(19) United States
(12) Patent Application Publication
(10) Pub. No.: US 2020/0409471 A1
(43) Pub. Date: Dec. 31, 2020

(54) HUMAN-MACHINE INTERACTION SYSTEM, METHOD, COMPUTER READABLE STORAGE MEDIUM AND INTERACTION DEVICE

(71) Applicant: Beijing Bytedance Network Technology Co., Ltd., Beijing (CN)

(72) Inventors: Tang Tang, Beijing (CN); Bo Zhang, Beijing (CN); Zhipeng Jiang, Beijing (CN); Linfu Wen, Beijing (CN)

(21) Appl. No.: 17/020,561

(22) Filed: Sep. 14, 2020

Related U.S. Application Data
(63) Continuation of application No. PCT/CN2019/075928, filed on Feb. 22, 2019.

(30) Foreign Application Priority Data
Mar. 29, 2018 (CN) 201810273850.7

(51) Int. Cl. G06F 3/01; G06F 3/03; G06F 3/16; G06K 9/00; G06T 7/20

(52) U.S. Cl. CPC G06F 3/017; G06F 3/011; G06F 3/0304; G06T 7/20; G06K 9/00335; G06K 9/00744; G06F 3/167

(57) ABSTRACT

Provided are a human-machine interaction system, a method, a computer readable storage medium, and an interaction device. The human-machine interaction system comprises an interaction module and a comparison module. The interaction module is used to display, on a display unit, one or more gesture images in a gesture template group, and to acquire a motion image of a human. The comparison module is configured to match the motion image of the human with the gesture image currently displayed, and to display a match result on the display unit.

The present application is a continuation of International Patent Application No. PCT/CN2019/075928 filed on Feb. 22, 2019, which claims priority to Chinese Patent Application No. 201810273850.7, titled “HUMAN-COMPUTER INTERACTION SYSTEM, METHOD, COMPUTER READABLE STORAGE MEDIUM AND INTERACTION DEVICE”, filed on Mar. 29, 2018 with the Chinese Patent Office, both of which are incorporated herein by reference in their entireties.

### FIELD

The present disclosure relates to the technical field of artificial intelligence, and in particular to a human-computer interaction system, a human-computer interaction method, a computer readable storage medium and a human-computer interaction device.

### BACKGROUND

The background described in the present disclosure belongs to technologies related to the present disclosure, and is intended to only illustrate and facilitate understanding content of the present disclosure. The background should not be understood as the prior art relative to an application date of the present application when the present application is filed for the first time, which is definitely confirmed by the applicant or is inferred to be confirmed by the applicant.

In recent years, the motion capture technology has become a key technology in research of human motion gestures, playing an increasingly important role. It is necessary to realize the interaction between human motions and information devices by recognizing the human motion gestures. Practically, the existing action capture technology is generally applied to large entertainment equipment, animation production, gait analysis, biochemical, and human-computer engineering. Due to advantages of being simple, convenient, and being not limited by time and locations, mobile devices such as a mobile phone and a tablet computer become popularized and essential devices for entertainment. Therefore, a problem to be urgently solved is how to apply the action capture technology to the mobile devices such as the mobile phone and the tablet computer, so as to provide users a good entertainment experience.

### SUMMARY

According to embodiments of a first aspect of the present disclosure, a human-computer interaction method is provided. The method includes:

displaying, on a display unit, one or more gesture images in a gesture template group, and acquiring a motion image of a human; and

matching the motion image of the human with the gesture image currently displayed, and displaying a matching result on the display unit.

Optionally, before the displaying, on a display unit, one or more gesture images in a gesture template group, and acquiring a motion image of a human, the method further comprises: extracting, in response to an instruction, a gesture template group corresponding to the instruction.

Optionally, before the displaying, on a display unit, one or more gesture images in a gesture template group, and acquiring a motion image of a human, the method further comprises:

extracting, in response to an instruction, audio corresponding to the instruction; and

playing the audio before the matching the motion image of the human with the gesture image currently displayed, and displaying a matching result on the display unit.

Optionally, the matching the motion image of the human with the gesture image currently displayed, and displaying a matching result on the display unit comprises:

extracting multiple single-frame images from the motion image of the human;

matching the single-frame image with the gesture image to generate a matching result; and

displaying at least one of a corresponding animation or a corresponding score on the display unit according to the matching result.

Optionally, the extracting, in response to an instruction, a gesture template group corresponding to the gesture comprises:

extracting one or more gesture images from multiple pre-stored gesture images to form the gesture template group corresponding to the instruction.

Optionally; the human-computer interaction method further comprises:

calculating, when the matching result includes a score, a sum of all displayed scores to obtain a total score after the gesture image is already displayed; and

matching the total score with preset score levels, and displaying a level to which the total score belongs on the display unit.

Optionally; before displaying the gesture image; the method further comprises:

detecting a distance between the human and a computer; and

starting to display the gesture image on the display unit in response to the distance between the human and the computer is within a preset range.

According to embodiments of a second aspect of the present disclosure, a human-computer interaction system is provided. The system includes an interaction module and a comparison module. The interaction module is configured to display, on a display unit, one or more gesture images in a gesture template group, and acquire a motion image of a human. The comparison module is configured to match the motion image of the human with the gesture image currently displayed, and display a matching result on the display unit.

Optionally, the human-computer interaction system further comprises an extraction module configured to extract; in response to an instruction, a gesture template group corresponding to the instruction.

Optionally, the human-computer interaction system further comprises an extraction module which is configured to extract, in response to an instruction, audio corresponding to the instruction; and an interaction module which is configured to control playing of the audio.

Optionally, the comparison module comprises a processing unit, a matching unit and an executing unit. The processing unit is configured to extract a plurality of single-frame images from the motion image of the human. The matching unit is configured to match the single-frame image with the gesture image to generate a matching result. The executing unit is configured to display at least one of a corresponding animation or a corresponding score on the display unit according to the matching result.

Optionally, the gesture template group includes one or more gesture images selected from multiple pre-stored gesture images.

Optionally, the human-computer interaction system further comprises a calculation module and a rating module. The calculation module is configured to calculate, when the matching result includes a score, a sum of all displayed scores to obtain a total score after the gesture image is already displayed. The rating module is configured to match the total score with preset score levels, and display a level to which the total score belongs on the display unit.

Optionally, the human-computer interaction system further includes a recognition module. The recognition module is configured to detect a distance between the human and a computer; and start to display the gesture image on the display unit in in response to the distance between the human and the computer is within a preset range.

According to embodiments of a third aspect of the present disclosure, a computer readable storage medium storing computer programs is provided. The programs are executed by a processor to perform steps of the human-computer interaction method described above.

According to embodiments of a fourth aspect of the present disclosure, a human-computer interaction device is provided. The device includes: a memory, a processor and programs which are stored in the memory and are executable by the processor. The processor executes the programs to perform steps of the human-computer interaction method described above.

According to the technical solution of the present disclosure, the gesture images (for example, multiple stick figures, animations and animal images presenting different gestures) are displayed on the display unit, and a user performs limb motions corresponding to the gesture images, so that dancing movement of the user is formed. In addition, images of the user are acquired, the motion images of the user are matched with the gesture images, and a matching result (such as a score and/or animation special effect) is displayed on the display unit according to a matching degree between the action of the user and the gesture image, so that the user who is not good at dancing is guided and the user can perform standard dancing actions, thereby the entertainment effect is improved, and therefore the experience effect of users is improved.

Additional aspects and advantages of the present disclosure become apparent from the description below, or may be known by implementing the present disclosure.

It should be understood that, the general description above and the detailed description below are schematic, and are intended to provide further illustration of the technical solution of the present disclosure.

### BRIEF DESCRIPTION OF THE DRAWINGS

The above and/or additional aspects and advantages of the present disclosure become apparent and easy to be understood in conjunction with the description of embodiments with reference to the drawings. In the drawings:

FIG. 1 is a schematic structural diagram of hardware of a terminal device according to an embodiment of the present disclosure;

FIG. 2 is a structural block diagram of a first embodiment of a human-computer interaction system according to the present disclosure;

FIG. 3 is a structural block diagram of a second embodiment of the human-computer interaction system according to the present disclosure;

FIG. 4 is a structural block diagram of a third embodiment of the human-computer interaction system according to the present disclosure;

FIG. 5 is a structural block diagram of a fourth embodiment of the human-computer interaction system according to the present disclosure;

FIG. 6 is a structural block diagram of a fifth embodiment of the human-computer interaction system according to the present disclosure;

FIG. 7 is a structural block diagram of a sixth embodiment of the human-computer interaction system according to the present disclosure;

FIG. 8 is a structural block diagram of a seventh embodiment of the human-computer interaction system according to the present disclosure;

FIG. 9 is a schematic flowchart of a first embodiment of a human-computer interaction method according to the present disclosure;

FIG. 10 is a schematic flowchart of a second embodiment of the human-computer interaction method according to the present disclosure;

FIG. 11 is a schematic flowchart of a third embodiment of the human-computer interaction method according to the present disclosure;

FIG. 12 is a schematic flowchart of a fourth embodiment of the human-computer interaction method according to the present disclosure;

FIG. 13 is a schematic flowchart of a fifth embodiment of the human-computer interaction method according to the present disclosure;

FIG. 14 is a schematic flowchart of a sixth embodiment of the human-computer interaction method according to the present disclosure;

FIG. 15 is a schematic flowchart of a seventh embodiment of the human-computer interaction method according to the present disclosure;

FIG. 16 is a schematic diagram of a computer readable storage medium according to an embodiment of the present disclosure; and

FIG. 17 is a schematic structural diagram of a human-computer interaction device according to an embodiment of the present disclosure.

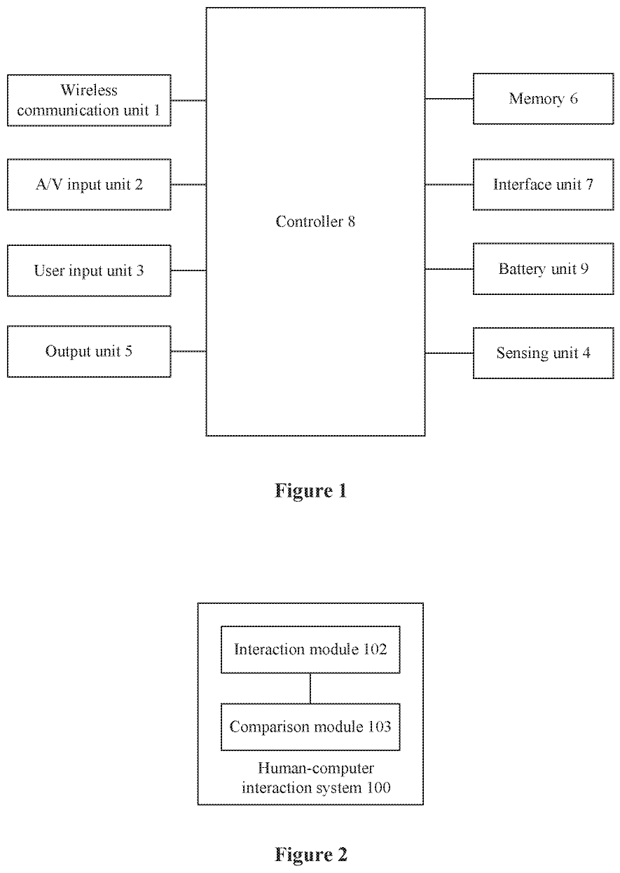

In FIGS. 1 to 8, FIG. 16, and FIG. 17, reference numerals and component names have the following correspondence:

| | | | | | |
|---|---|---|---|---|---|
| 100 | human-computer | | | 101 | extraction |
| | interaction system | | | | module |
| 1011 | image unit | 1012 | audio unit | 102 | interaction |
| 103 | comparison module | 1031 | processing unit | | module |
| 1032 | matching unit | 1033 | executing unit | | |
| 104 | calculating module | 105 | rating module | | |
| 106 | recognizing module | 1 | wireless communi- | | |
| | | | cation unit | | |
| 2 | input unit | 3 | user input unit | | |
| 4 | sensing unit | 5 | output unit | | |
| 6 | memory | 7 | interface unit | | |
| 8 | controller | 9 | power supply unit | | |
| 80 | human-computer | 801 | memory | | |
| | interaction device | | | | |
| 802 | processor | 900 | computer readable | | |
| 901 | non-transient computer | | storage medium | | |
| | readable instruction | | | | |

### DETAILED DESCRIPTION OF EMBODIMENTS

In order to understand the above objects, features and advantages of the present disclosure more clearly, the present disclosure is described in detail blow with reference to the drawings and specific embodiments. It should be noted that, the embodiments of the present disclosure and features in the embodiments may be combined without a conflict.

Specific details are clarified in the description below to fully understand the present disclosure. However, the present disclosure may be implemented by other manners different from the manners described herein. Therefore, the protection scope of the present disclosure is not limited by specific embodiments disclosed below.

Multiple embodiments are discussed below. Each embodiment represents a single combination of the present disclosure, but different embodiments of the present disclosure may be replaced or combined. Therefore, the present disclosure may be considered as including all possible combinations of same and/or different embodiments recorded. Therefore, if one embodiment includes A, B and C and another embodiment includes a combination of B and D, the present disclosure should be considered as including embodiments which include all possible combinations of one or more of A, B, C and D, although such embodiments are not explicitly described below.

As shown in FIG. 1, the human-computer interaction device, that is, a terminal device, may be implemented in various forms. The terminal device in the present disclosure may include but not limited to a mobile terminal device such as a mobile phone, a smart phone, a notebook computer, a digital broadcast receiver, a PDA (personal digital assistant), a PAD (tablet computer), PMP (portable multimedia player), a navigation device, a vehicle-mounted terminal device, a vehicle-mounted display terminal and a vehicle-mounted electronic rear-view mirror; and a fixed terminal device such as a digital TV and a desktop computer.

In an embodiment of the present disclosure, the terminal device includes a wireless communication unit 1, an A/V (audio/video) input unit 2, a user input unit 3, a sensing unit 4, an output unit 5, a memory 6, an interface unit 7, a controller 8 and a power supply unit 9. The A/V (audio/video) input unit 2 includes but not limited to: a camera, a front camera, a rear camera and various types of audio/video input device. It should be understood by those skilled in the art that the terminal devices described above may include less or more components than those described above.

Those skilled in the art should understand that the embodiments described here may be implemented by for example computer software, hardware or any form of computer readable medium. In a case of implementing by hardware, the embodiments described herein may be implemented by at least one of an application specific integrated circuit (ASIC), a digital signal processor (DSP), a digital signal processing apparatus (DSPD), a programmable logic device (PLD), a field programmable gate array (FPGA), a processor, a controller, a microcontroller and a microprocessor. In some cases, such embodiments may be implemented in a controller. In case of implementing by software, such as for embodiments of process or function, the embodiments may be implemented by a single software module executing at least one type of function or operation. The software code may be implemented by a software application program (or a program) written by any suitable programming language, and the software code may be stored in the memory and is executed by the controller.

As shown in FIG. 2, a human-computer interaction system 100 according to an embodiment in a first aspect of the present disclosure includes an interaction module 102 and a comparison module 103.

According to a schematic embodiment, the interaction module 102 is configured to display, on a display unit, one or more gesture images in a gesture template group, and acquire a motion image of a human. The comparison module 103 is configured to match the motion image of the human with the gesture image currently displayed, and display a matching result on the display unit.

According to the human-computer interaction system 100 of the present disclosure, the gesture images (such as multiple stick figures, animations and animal images presenting different gestures) are displayed on the display unit (the display unit may be display screen). The gesture images display positions, angles and so on of a hand, an upper arm, a lower arm, a thigh, a calf, a torso and a head at different time instants. The user performs limb motions corresponding to the gesture images, so that dancing movement of the user is formed. In addition, the interaction module acquires images of the user, and the comparison module matches the motion images of the human with the gesture image and displays a matching result (such as a score and/or animation special effect) on the display unit according to a matching degree between the actions of the human and the gesture image, so that the user who is not good at dancing is guided and thus the user can perform standard dancing actions, thereby the entertainment effect is improved, and therefore the experience effect of users is improved.

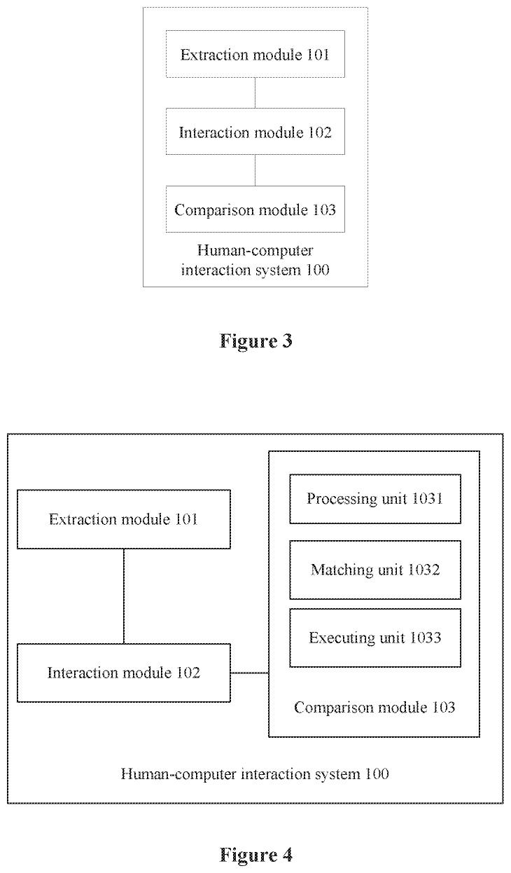

As shown in FIG. 3, the human-computer interaction system 100 according to the embodiment of the first aspect of the present disclosure includes: an extraction module 101, an interaction module 102 and a comparison module 103.

According to a schematic embodiment, the extraction module 101 is configured to extract, in response to an instruction, a gesture template group corresponding to the instruction. The interaction module 102 is configured to display, on a display unit, one or more gesture images in a gesture template group, and acquire a motion image of a human. The comparison module 103 is configured to match the motion image of the human with the gesture image currently displayed, and display a matching result on the display unit.

According to the human-computer interaction system 100 of the present disclosure, the gesture images (such as multiple stick figures, animations and animal images presenting different gestures) are displayed on the display unit (the display unit may be display screen) The gesture images display positions, angles and so on of a hand, an upper arm, a lower arm, a thigh, a calf, a torso and a head at different time instants. The user performs limb actions corresponding to the gesture images, so that the user dances. In addition, the interaction module acquires images of the user, and the comparison module matches the motion images of the human with the gesture image and displays a matching result (such as a score and/or animation special effect) on the display unit according to a matching degree between the actions of the human and the gesture image, so that the user who is not good at dancing is guided and thus the user can perform standard dancing actions, thereby the entertainment effect is improved, and therefore the experience effect of users is improved.

In an embodiment of the present disclosure, the extraction module 101 is configured to extract, in response to an instruction, a gesture template group and audio corresponding to the instruction. The interaction module 102 is configured to control playing of the audio, display multiple gesture images in the gesture template group on the display unit, and acquire a motion image of a human. The comparison module 103 is configure to match the motion image of the human with the gesture image currently displayed, and display a matching result on the display unit.

According to the human-computer interaction system 100 of the present disclosure, the gesture images (such as multiple stick figures, animations and animal images presenting different gestures) are displayed on the playing display unit of music (the display unit may be a display screen). The gesture images display positions, angles and so on of a hand, an upper arm, a lower arm, a thigh, a calf, a torso and a head at different time instants. The user performs limb actions corresponding to the gesture images in response to the music, so that dancing movement of the user is formed. In addition, the interaction module acquires images of the user, and the comparison module matches the motion images of the human with the gesture image and displays a matching result (such as a score and/or animation special effect) on the display unit according to a matching degree between the actions of the human and the gesture image, so that the user who is not good at dancing is guided and thus the user can perform standard dancing actions, thereby the entertainment effect is improved, and therefore the experience effect of users is improved.

In an embodiment of the present disclosure, as shown in FIG. 4, the comparison module 103 includes: a processing unit 1031, a matching unit 1032 and an executing unit 1033.

According to a schematic embodiment, the processing unit 1031 is configured to extract a plurality of single-frame images from the motion image of the human. The matching unit 1032 is configured to match the single-frame image with the gesture image to generate a matching result. The executing unit 1033 is configured to display at least one of a corresponding animation or a corresponding score on the display unit according to the matching result.

In the embodiment, the processing unit 1031 extracts a plurality of single-frame images from the acquired motion images of the human. It is assumed that one hundred frames of images are extracted in unit time. The matching unit 1032 matches the one hundred frames of images with the gesture images, to determine a coincidence rate of the one hundred frames of images with the gesture images. With this detection manner, accurate detection can be realized, thereby detecting accuracy of a product is improved and thus the experience effect of the product is improved. The display unit displays at least one of a corresponding animation or a corresponding score. The animation may be digital animation such as perfect, good, great and miss, or special effect displayed on the display unit, such as heart rain or star rain.

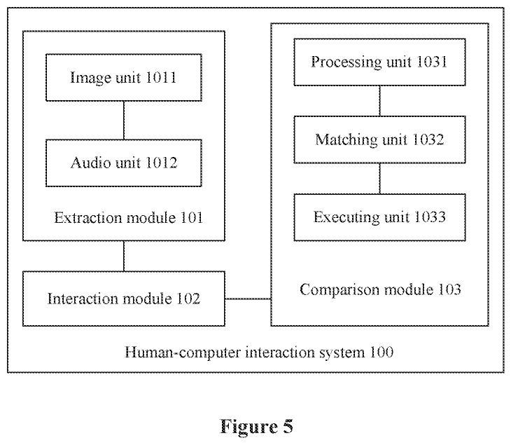

In an embodiment of the present disclosure, as shown in FIG. 5, the extraction module 101 includes an image unit 1011 and an audio unit 1012.

According to a schematic embodiment, the image unit 1011 is configured to extract one or more gesture images from multiple gesture images to form a gesture template group corresponding to an instruction. The audio unit 1012 is configured to play audio corresponding to the instruction.

In the embodiment, the image unit 1011 pre-stores many gesture templates, and the image unit 1011 extracts and ranks multiple gesture templates in response to different instructions selected by the user, to form a gesture template group. In an embodiment of the present disclosure, there are one hundred gesture templates; in response to a first instruction, the first, the third, the fifth, the twentieth, the sixty-sixth, the seventy-eighth, the eighty-second and the ninety-sixth gesture templates are extracted to form a gesture template group; in response to a second instruction, the second, the twelfth, the twenty-second, the twenty-fifth, the thirty-seventh, the forty-seventh, the fifty-fifth, the sixty-ninth, the seventy-third, the eighty-sixth and the ninety-sixth gesture templates are extracted to form a gesture template group; and in response to a third instruction, the seventh, the thirteenth, the twenty-ninth, the thirty-fifth, the thirty-eighth, the forty-sixth, the fifty-second, the sixty-eighth, the seventy-first, the eighty-sixth and the ninety-first gesture templates are extracted to form a gesture template group. The audio unit 1012 extracts corresponding music in response to different instructions selected by the user.

In the embodiment of the present disclosure, many gesture templates are pre-stored in the extraction module 101. The gesture template is composed of one or more gesture images selected from multiple pre-stored gesture images. The extraction module 101 extracts and ranks multiple gesture templates in response to selection instructions of the user, to form a gesture template group. According to an embodiment of the present disclosure, there are one hundred gesture templates; in response to a first selection instruction, the first, the third, the fifth, the twentieth, the sixty-sixth, the seventy-eighth, the eighty-second and the ninety-sixth gesture templates are extracted to form a gesture template group; in response to a second selection instruction, the second, the twelfth, the twenty-second, the twenty-fifth, the thirty-seventh, the forty-seventh, the fifty-fifth, the sixty-ninth, the seventy-third, the eighty-sixth and the ninety-sixth gesture templates are extracted to form a gesture template group; and in response to a third selection instruction, the seventh, the thirteenth, the twenty-ninth, the thirty-fifth, the thirty-eighth, the forty-sixth, the fitly-second, the sixty-eighth, the seventy-first, the eighty-sixth and the ninety-first gesture templates are extracted to form a gesture template group.

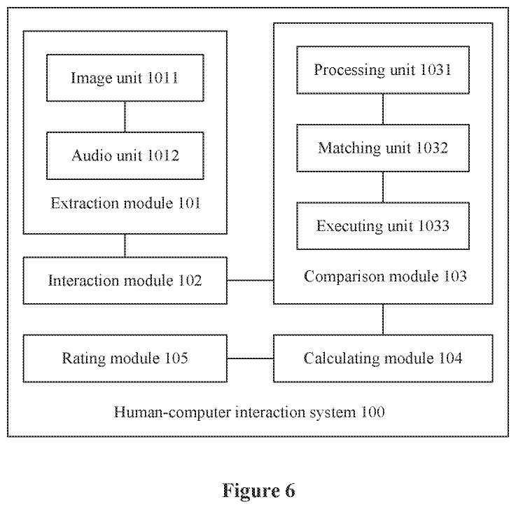

In an embodiment of the present disclosure, as shown in FIG. 6, the human-computer interaction system 100 includes a calculating module 104 and a rating module 105.

According to a schematic embodiment, the calculating module 104 is configured to calculate a sum of all displayed scores to obtain a total score after the audio is already played or the gesture image is already displayed, when that the matching result includes a score. The rating module 105 is configured to match the total score with preset score levels, and displays a level to Which the total score belongs on the display unit.

In the embodiment, the user may know the score and the level of the dance by the calculating module 104 and the rating module 105. In one aspect, the user may rank scores and levels of the user and other users, thereby increasing interactivity and interest of the product. In another aspect, the user can share a video carrying the score and the level with a friend, so that the friend can directly evaluate the dance of the user.

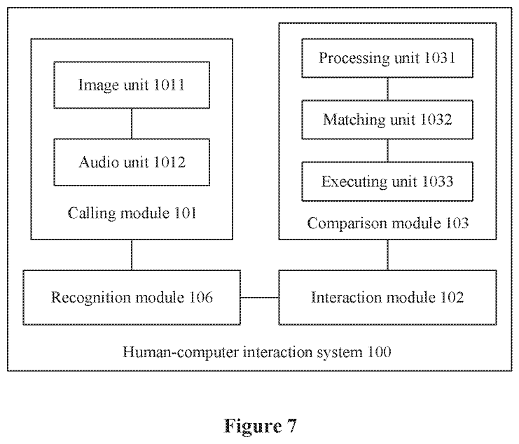

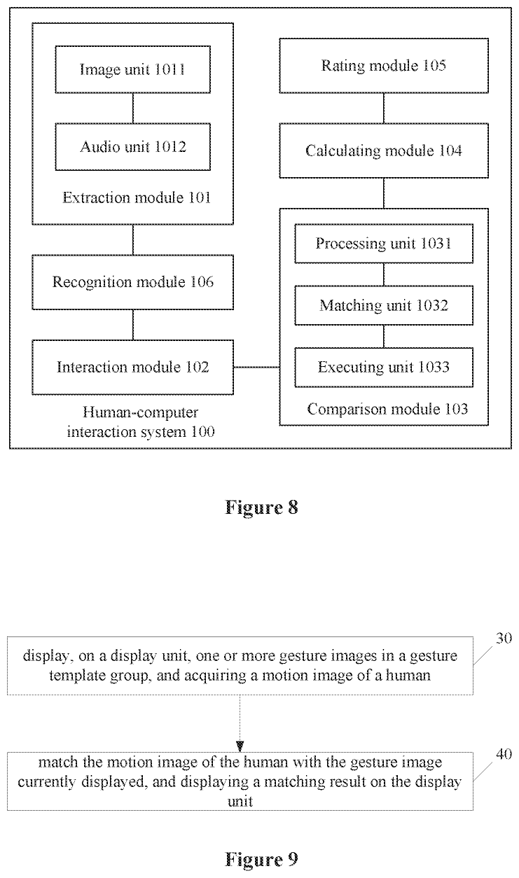

In an embodiment of the present disclosure, as shown in FIG. 7 and FIG. 8, the human-computer interaction system 100 further includes a recognition module 106. The recognition module 106 is configured to: detect a distance between a human and a computer; and start to play audio and/or start to display the gesture image on the display unit in a case that the distance between the human and the computer is within a preset range.

In the embodiment, the recognition module 106 is provided. In one aspect, images of the user can be completely displayed in the display unit, so that the dancing action of the user can better match the gesture images displayed on the display unit, to avoid a case that matching is inaccurate since an image of a body of the user goes beyond the display unit, thereby improving use comfort of the product, and thus improving market competitiveness of the product. In another aspect, the distance between the user and a mobile phone is set to be in a reasonable range, so that the user can clearly see content displayed on the display unit, thereby increasing use comfort of the product and increasing market competitiveness of the product.

### First Embodiment

As shown in FIG. 9, a human-computer interaction method according to embodiments of a second aspect of the present disclosure includes steps 30 and 40 in the following.

In step 30, one or more gesture images in a gesture template group are displayed on a display unit, and an motion image of a human is acquired.

In step 40, the motion image of the human is matched with the gesture image currently displayed, and a matching result is displayed on the display unit.

According to the human-computer interaction method of the present disclosure, the gesture images (such as multiple stick figures, animations and animal images presenting different gestures) are displayed on the display unit (the display unit may be a display screen). The gesture images display positions, angles and so on of a hand, an upper arm, a lower arm, a thigh, a calf, a torso and a head at different time instants. The user performs limb actions corresponding to the gesture images, so that the user dances. In addition, images of the user are acquired, and the motion images of the human are matched with the gesture image and a matching result (such as a score and/or animation special effect) is displayed on the display unit according to a matching degree between the actions of the human and the gesture image, so that the user who is not good at dancing is guided and thus the user can perform standard dancing actions, thereby the entertainment effect is improved, and therefore the experience effect of users is improved.

### Second Embodiment

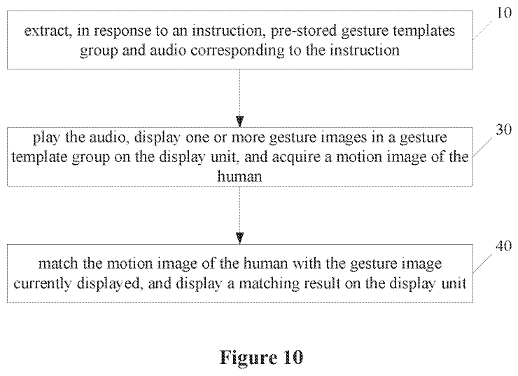

In an embodiment of the present disclosure, as shown in FIG. 10, the human-computer interaction method in the embodiment includes step 10, step 30 and step 40.

In step 10, in response to an instruction, a gesture template group and audio corresponding to the instruction are extracted.

In step 30, the audio is played, one or more gesture images in the gesture template group are displayed on a display unit, and a motion image of a human is acquired.

In step 40, the motion image of the human is matched with the gesture image currently displayed, and a matching result is displayed on the display unit.

According to the human-computer interaction method of the present disclosure, the gesture images (such as multiple stick figures, animations and animal images presenting different gestures) are displayed on the playing display unit of music (the display unit may be a display screen), The gesture images display positions, angles and so on of a hand, an upper arm, a lower arm, a thigh, a calf, a torso and a head at different time instants. The user performs limb actions corresponding to the gesture images in response to the music, so that dancing movement of the user is formed. In addition, images of the user are acquired, and the motion images of the human are matched with the gesture image and a matching result (such as a score and/or animation special effect) is displayed on the display unit according to a matching degree between the actions of the human and the gesture image, so that the user who is not good at dancing is guided and thus the user can perform standard dancing actions, thereby improving entertainment effect and thus improving the user experience.

### Third Embodiment

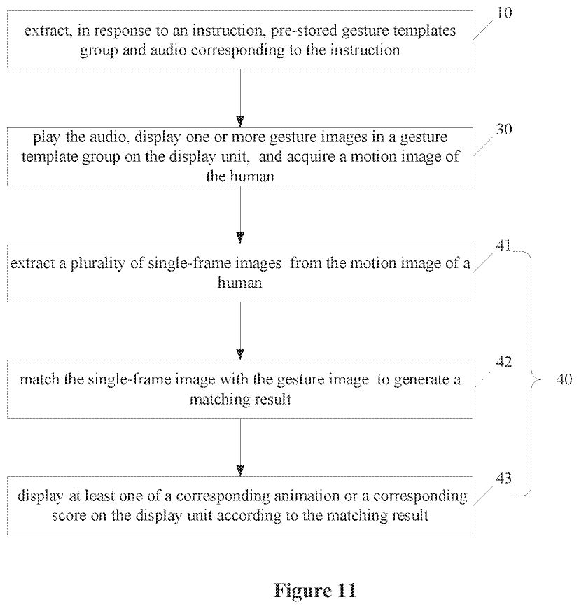

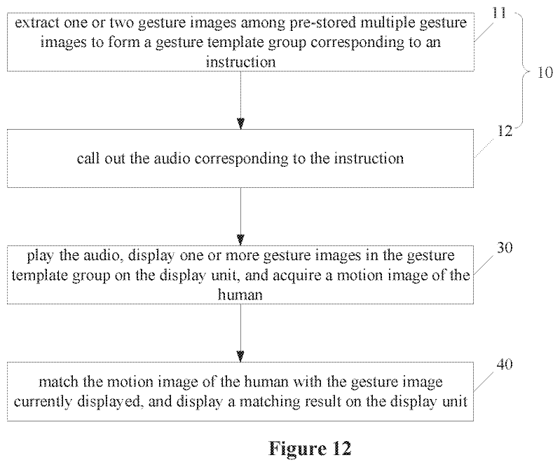

In an embodiment of the present disclosure, as shown in FIG. 11, step 40 includes step 41 to step 43 in the following.

In step 41, a plurality of single-frame images are extracted from a motion image of a human.

In step 42, the single-frame image is matched with the gesture image, to generate a matching result.

In step 43, a corresponding animation and/or score is displayed on a display unit according to the matching result.

In the embodiment, the human-computer interaction method includes step 30, step 41, step 42 and step 43.

In step 10, in response to an instruction, a gesture template group and audio corresponding to the instruction are extracted.

In step 30, the audio is played, one or more gesture images in the gesture template group are displayed on a display unit, and a motion image of the human is acquired.

In step 41, a plurality of single-frame images are extracted from the motion image of the human.

In step 42, the single-frame image is matched with the gesture image, to generate a matching result.

In step 43, at least one of a corresponding animation or a corresponding score is displayed on the display unit according to the matching result.

In the embodiment, multiple single-frame images are extracted from the acquired motion images of the human. It is assumed that one hundred frames of images are extracted in unit time. The matching unit matches the one hundred frames of images with the gesture images, to determine a coincidence rate of the one hundred frames of images with the gesture images. With this detection manner, accurate detection can be realized, thereby improving detecting accuracy of a product and thus improving the experience effect of the product. The display unit displays the at least one of a score or an animation. The animation may be digital animation such as perfect, good, great and miss, or special effect displayed on the display unit, such as heart rain or star rain.

### Fourth Embodiment

In an embodiment of the present disclosure, as shown in FIG. 12, step 10 includes steps 11 and 12.

In step 11, one or more gesture images among multiple gesture images are extracted to form a gesture template group corresponding to an instruction.

In step 12, audio corresponding to an instruction is called out.

In the embodiment, the human-computer interaction method includes step 11, step 12, step 30 and step 40.

In step 11, one or more gesture images are extracted from multiple pre-stored gesture images, to form a gesture template group corresponding to an instruction.

In step 12, audio corresponding to an instruction is called out.

In step 30, the audio is played, one or more gesture images in a gesture template group are displayed on a display unit, and a motion image of a human is acquired.

In step 40, the motion image of the human is matched with the gesture image currently displayed, and a matching result is displayed on the display unit.

In the embodiment, many gesture templates are pre-stored. The gesture template group is composed of one or more gesture images selected from pre-stored multiple gesture images. Multiple gesture templates are extracted and ranked in response to selection instructions of the user, to form a gesture template group. In an embodiment of the present disclosure, there are one hundred gesture templates; in response to a first selection instruction, the first, the third, the fifth, the twentieth, the sixty-sixth, the seventy-eighth, the eighty-second and the ninety-sixth gesture templates are extracted to form a gesture template group; in response to a second selection instruction, the second, the twelfth, the twenty-second, the twenty-fifth, the thirty-seventh, the forty-seventh, the fifty-fifth, the sixty-ninth, the seventy-third, the eighty-sixth and the ninety-sixth gesture templates are extracted to form a gesture template group; and in response to a third selection instruction, the seventh, the thirteenth, the twenty-ninth, the thirty-fifth, the thirty-eighth, the forty-sixth, the fifty-second, the sixty-eighth, the seventy-first, the eighty-sixth and the ninety-first gesture templates are extracted to form a gesture template group. Corresponding music is extracted in response to the selection instructions of the user.

### Fifth Embodiment

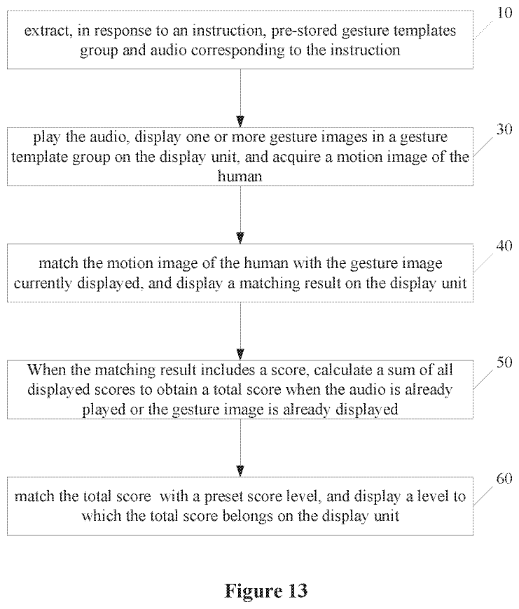

In an embodiment of the present disclosure, as shown in FIG. 13, the human-computer interaction method further includes step 50 and step 60.

In step 50, when the matching result includes a score, a sum of all displayed scores is calculated to obtain a total score when the audio is already played or the gesture image is already displayed.

In step 60, the total score is matched with a preset score level, and a level to which the total score belongs is displayed on the display unit.

In the embodiment, the human-computer interaction method includes: step 10, step 30, step 40, step 50 and step 60.

In step 10, in response to an instruction, a gesture template group and audio corresponding to the instruction are extracted.

In step 30, the audio is played, one or more gesture images in the gesture template group are displayed on the display unit, and a motion image of a human is acquired.

In step 40, the motion image of the human is matched with the gesture image currently displayed, and a matching result is displayed on the display unit.

In step 50, when the matching result includes a score, a sum of all displayed scores is calculated to obtain a total score when the audio is already played or the gesture image is already displayed.

In step 60, the total score is matched with a preset score level, and a level to which the total score belongs is displayed on the display unit.

In the embodiment, the user may know the score and the level of the dance. In one aspect, the user may rank scores and levels of the user and other users, thereby increasing interactivity and interest of the product. In another aspect, the user can share a video carrying the score and the level with a friend, so that the friend can directly evaluate the dance of the user.

### Sixth Embodiment

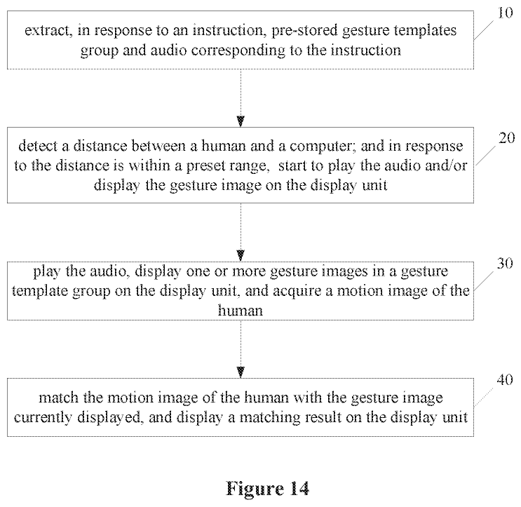

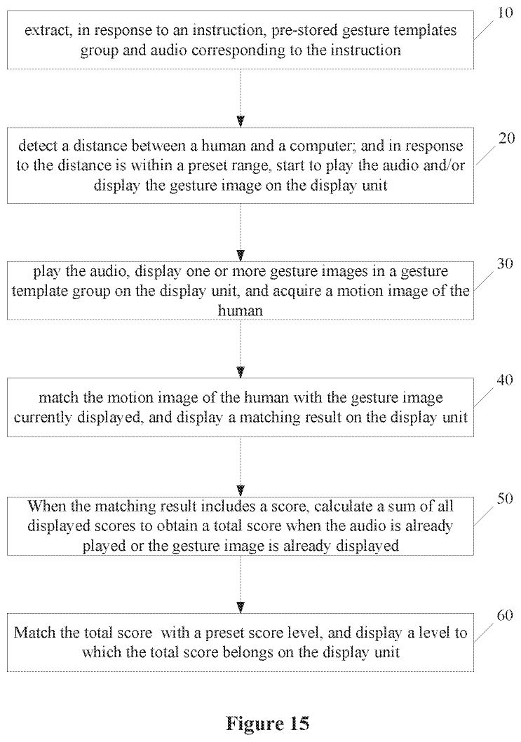

In an embodiment of the present disclosure, as shown in FIG. 14 and FIG. 15, before the gesture image is displayed, the method further includes step 20.

In step 20, a distance between a human and a computer is detected; and in response to the distance between the human and the computer is within a preset range, it is started to play the audio and/or display the gesture image on the display unit.

As shown in FIG. 14, the human-computer interaction method in the embodiment includes step 10, step 20, step 30 and step 40.

In step 10, in response to an instruction, a gesture template group and audio corresponding to the instruction are extracted.

In step 20, a distance between the human and the computer is detected; and in a case that the distance between the human and the computer is in a preset range, it is started to play the audio and/or display the gesture image on the display unit.

In step 30, the audio is played, one or more gesture images in a gesture template group are displayed on the display unit, and a motion image of the human is acquired.

In step 40, the motion image of the human is matched with the gesture image currently displayed, and a matching result is displayed on the display unit.

### Seventh Embodiment

Alternatively, as shown in FIG. 15, the human-computer interaction method includes steps 10 to 60 in the following.

In step 10, in response to an instruction, a gesture template group and audio corresponding to the instruction are extracted.

In step 20, the distance between the human and the computer is detected; and when the distance between the human and the computer is within a preset range, it is started to play the audio and/or display the gesture image on the display unit.

In step 30, the audio is played, one or more gesture images in a gesture template group are displayed on the display unit, and a motion image of the human is acquired.

In step 40, the motion image of the human is matched with the gesture image currently displayed, and a matching result is displayed on the display unit.

In step 50, when that the matching result includes a score, a sum of all displayed scores is calculated to obtain a total score when the audio is already played or the gesture image is already displayed.

In step 60, the total score is matched with a preset score level, and a level to which the total score belongs is displayed on the display unit.

In the embodiment, the recognition is performed. In one aspect, images of the user can be completely displayed in a display region of the display unit, so that the dancing action of the user can better match the gesture images displayed on the display unit, to avoid a case that matching is inaccurate since an image of a body of the user goes beyond the display unit, thereby improving use comfort of the product, and thus improving market competitiveness of the product. In another aspect, the distance between the user and a mobile phone is set to be in a reasonable range, so that the user can clearly see content displayed on the display unit, thereby increasing use comfort of the product and thus increasing market competitiveness of the product.

In an embodiment of the present disclosure, a recognition frame is displayed on the display unit. When the image of the human is located in the recognition frame, it is started to play audio or display the gesture image on the display unit. Optionally, the recognition frame is a human-shaped frame, and the human-shaped frame displays a whole shape of the human. The user performs an action the same as a shape of the human-shaped frame; and when the whole of the user is located in the human-shaped frame, it is started to play the audio or display the gesture image on the display unit. Countdown is displayed on the display unit, and it is started to play the audio when the countdown ends. In another embodiment of the present disclosure, the recognition frame is a human-shaped frame, and the human-shaped frame display a shape of an upper body (or a lower body) of the human. The user performs an action the same as a shape of the human-shaped frame; and when the upper body of the user is located in the human-shaped frame, it is started to play the audio or display the gesture image on the display unit. Countdown is displayed on the display unit, and it is started to play the audio when the countdown ends. Those skilled in the art should understand that the recognition frame is configured to recognize a target to ensure smooth performing of the interaction. Therefore, any recognition frame with the recognition function falls within the protection scope of the present disclosure.

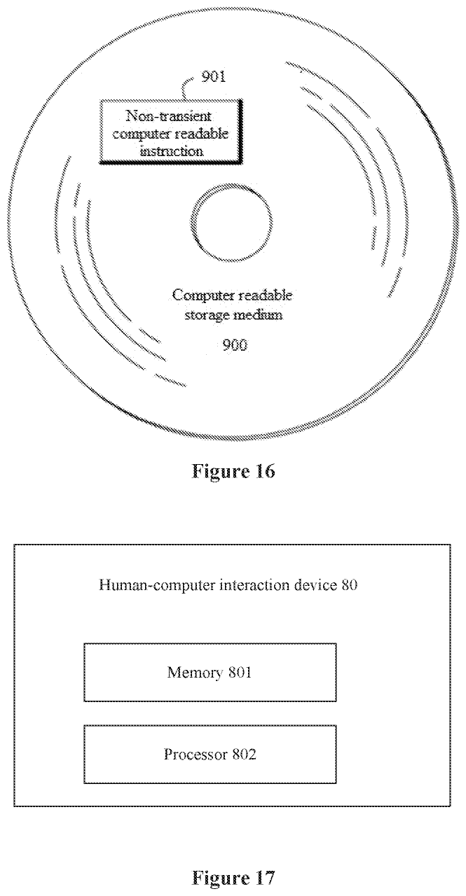

As shown in FIG. 16, a computer readable storage medium is provided according to embodiments of a third aspect of the present disclosure. The computer readable storage medium stores computer programs, and the programs are executed by a processor to perform steps of any of the above human-computer interaction methods. The computer readable storage medium may include but not limited to any type of disks, such as a flash memory, a hard disk, a multimedia card, a card type memory (such as SD or DX memory), a static random access memory (SRAM), an electronic erasable programmable readable memory (EEPROM), a programmable read only memory (PROM), a magnetic memory, a floppy disk, an optical disk, a DVD, a CD-ROM, a micro driver, a magnetic optical disk, ROM, RAM, EPROM, EEPROM, DRAM, VRAM, a flash memory device, a magnetic card, an optical card, a nanosystem (including a molecular memory IC), or any type of medium or device which is adaptable to store instructions and/or data. In an embodiment of the present disclosure, the computer readable storage medium 900 stores a non-transient computer readable instruction 901. When the non-transient computer readable instruction 901 is executed by the processor, the human-computer interaction method based on the human action gesture described in the above embodiments is performed.

A human-computer interaction device is provided according to embodiments of a fourth aspect of the present disclosure. The human-computer interaction device includes: a memory, a processor, and programs which are stored in the memory and are executable by the processor. The processor executes the programs to perform steps of the human-computer interaction method described in any above embodiment.

In an embodiment of the present disclosure, the memory is configured to store non-transient computer readable instructions. According to a schematic embodiment, the memory may include one or more computer program products. The computer program product may include various forms of computer readable storage medium, for example volatile memory and/or non-volatile memory. The volatile memory may include for example a random access memory (RAM) and/or a high speed cache memory (cache). The non-volatile memory may include for example a read only memory (ROM), a hard disk and a flash memory. In an embodiment of the present disclosure, the processor may be a central processing unit (CPU) or a processing unit of other forms with the data processing capability and/or the instruction executing capability, and may control other components in the human-computer interaction device to achieve a desired function. In an embodiment of the present disclosure, the processor is configured to execute the computer readable instruction stored in the memory, so that the human-computer interaction device performs the above interaction method.

In an embodiment of the present disclosure, as shown in FIG. 17, a human-computer interaction device 80 includes a memory 801 and a processor 802. Components in the human-computer interaction device 80 are connected to each other via a bus system and/or a connection mechanism of other forms (not shown).

The memory 801 is configured to store non-transient computer readable instructions. According to a schematic embodiment, the memory 801 may include one or more computer program products. The computer program product may include various forms of computer readable storage medium, for example volatile memory and non-volatile memory. The volatile memory may include for example a random access memory (RAM) and/or a high speed cache memory (cache). The non-volatile memory may include for example a read only memory (ROM), a hard disk and a flash memory.

The processor 802 may be a central processing unit (CPU) or a processing unit of other forms with the data processing capability and/or instruction executing capability, and may control other components in the human-computer interaction device 80 to execute the desired functions. In an embodiment of the present disclosure, the processor 802 is configured to execute computer readable instructions stored in the memory 801, so that the human-computer interaction device 80 performs the human-computer interaction method based on the dynamic gesture of the human. For the human-computer interaction device, one may refer to embodiments of the human-computer interaction method based on the dynamic gesture of the human. Details are not described herein.

In an embodiment of the present disclosure, the human-computer interaction device is a mobile device. A camera of the mobile device acquires images of the user. Songs and gesture template groups corresponding to the instruction are downloaded by the mobile device. After the songs and the gesture template groups are downloaded, a recognition frame (which may be a human-shaped frame) is display on a display unit of the mobile device. A distance between the user and the mobile device is adjusted, so that the image of the user is displayed in the recognition frame. The mobile device starts to play music, and at the same time, multiple gesture images (such as multiple stick figures, animations and animal images presenting different gestures) are displayed on the display unit. The user starts to dance, so that body motions of the user match the gesture images. According to a matching degree between the actions of the user and the gesture images, scores and/or animations (the animation may be digital animations such as perfect, good, great and miss, or special effect displayed on the display unit such as heart rain or star rain) are displayed on the display unit. After playing of the music is finished, scores and levels are displayed on the display unit of the mobile device. The user may download his dancing video, share the video or place the video in a ranking list. The mobile device may be a mobile phone or a tablet computer.

In the present disclosure, the term of “multiple” refers to two or more, unless explicitly defined. The terms of “mount”, “connected”, “connection” and “fixed” should be understood broadly. For example, the “connection” may be fixed connection, removable connection or integral connection. The “connected” may be directly connected, or may be indirectly connected via a medium component. Those skilled in the art may understand that specific meanings of the above terms in the present disclosure according to the context.

In description of the present Specification, the terms of “an embodiment”, “some embodiments” and “specific embodiments” indicate that specific features, structures, materials or features described in conjunction with the embodiment or example are included in at least one embodiment or example of the present disclosure. In the present Specification, the schematic embodiments are unnecessary to indicate the same embodiments or examples. In addition, the described features, structures, materials or features may be combined in a suitable manner in one or more embodiments or examples.

Optional embodiments of the present disclosure are described above and are not intended to limit the present disclosure. Those skilled in the art may make various modifications and variations to the present disclosure. Any change, equivalent replacement and improvement made within the spirit and principle of the present disclosure should fall within the protection scope of the present disclosure.

1. A human-computer interaction method, comprising:
displaying, on a display unit, one or more gesture images in a gesture template group, and acquiring a motion image of a human; and
matching the motion image of the human with the gesture image currently displayed, and displaying a matching result on the display unit.

2. The human-computer interaction method according to claim 1, wherein before the displaying, on a display unit, one or more gesture images in a gesture template group, and acquiring a motion image of a human, the method further comprises:
extracting, in response to an instruction, a gesture template group corresponding to the instruction.

3. The human-computer interaction method according to claim 1, wherein before the displaying, on a display unit, one or more gesture images in a gesture template group, and acquiring a motion image of a human, the method further comprises:
extracting, in response to an instruction, audio corresponding to the instruction; and
playing the audio before the matching the motion image of the human with the gesture image currently displayed, and displaying a matching result on the display unit.

4. The human-computer interaction method according to claim 1, wherein the matching the motion image of the human with the gesture image currently displayed, and displaying a matching result on the display unit comprises:
extracting a plurality of single-frame images from the motion image of the human;
matching the single-frame image with the gesture image to generate a matching result; and
displaying at least one of a corresponding animation or a corresponding score on the display unit according to the matching result.

5. The human-computer interaction method according to claim 2, wherein the extracting, in response to an instruction, a gesture template group corresponding to the instruction comprises:
extracting one or more gesture images from a plurality of pre-stored gesture images to form the gesture template group corresponding to the instruction.

6. The human-computer interaction method according to claim 4, wherein further comprising:
calculating, when the matching result comprises a score, a sum of all displayed scores to obtain a total score after the gesture image is already displayed; and
matching the total score with preset score levels, and displaying a level to which the total score belongs on the display unit.

7. The human-computer interaction method according to claim 1, wherein before displaying the gesture image, the method further comprises:
detecting a distance between the human and a computer; and
starting to display the gesture image on the display unit in response to the distance between the human and the computer is within a preset range.

8. A human-computer interaction device, comprising:
at least one processor; and
at least one memory communicatively coupled to the at least one processor and storing instructions that upon execution by the at least one processor cause the device to:
displaying, on a display unit, one or more gesture images in a gesture template group, and acquiring a motion image of a human; and
matching the motion image of the human with the gesture image currently displayed, and displaying a matching result on the display unit.

9. The human-computer interaction device according to claim 8, wherein before the displaying, on a display unit, one or more gesture images in an gesture template group, and acquiring a motion image of a human, the at least one memory further stores instructions that upon execution by the at least one processor cause the device to:
extracting, in response to an instruction, a gesture template group corresponding to the instruction.

10. The human-computer interaction device according to claim 8, wherein before the displaying, on a display unit, one or more gesture images in a gesture template group, and acquiring a motion image of a human, the at least one memory further stores instructions that upon execution by the at least one processor cause the device to:
extracting, in response to an instruction, audio corresponding to the instruction; and
playing the audio before the matching the motion image of the human with the gesture image currently displayed, and displaying a matching result on the display unit.

11. The human-computer interaction device according to claim 8, wherein the matching the motion image of the human with the gesture image currently displayed, and displaying a matching result on the display unit comprising:
extracting a plurality of single-frame images from the motion image of the human;
matching the single-frame image with the gesture image to generate a matching result; and
displaying at least one of a corresponding animation or a corresponding score on the display unit according to the matching result.

12. The human-computer interaction device according to claim 9, wherein the extracting, in response to an instruction, a gesture template group corresponding to the instruction comprising:
extracting one or more gesture images from a plurality of pre-stored gesture images to form the gesture template group corresponding to the instruction.

13. The human-computer interaction device according to claim 11, wherein the at least one memory further stores instructions that upon execution by the at least one processor cause the device to:
calculating, when the matching result comprises a score, a sum of all displayed scores to obtain a total score after the gesture image is already displayed; and
matching the total score with preset score levels, and displaying a level to which the total score belongs on the display unit.

14. The human-computer interaction device according to claim 8, wherein before displaying the gesture image, the at least one memory further stores instructions that upon execution by the at least one processor cause the device to:
detecting a distance between the human and a computer;
starting to display the gesture image on the display unit in response to the distance between the human and the computer is within a preset range.

15. A non-transitory computer readable storage medium having stored thereon non-transitory computer readable instructions that, when executed by a computer, cause the computer to perform operations, the operations comprising:
displaying, on a display unit, one or more gesture images in a gesture template group, and acquiring a motion image of a human; and
matching the motion image of the human with the gesture image currently displayed, and displaying a matching result on the display unit.

16. The non-transitory computer readable storage medium according to claim 15, wherein before the displaying, on a display unit, one or more gesture images in a gesture template group, and acquiring a motion image of a human, the operations further comprises:
extracting, in response to an instruction, a gesture template group corresponding to the instruction.

17. The non-transitory computer readable storage medium according to claim 15, wherein before the displaying, on a display unit, one or more gesture images in a gesture template group, and acquiring a motion image of a human, the operations further comprises:
extracting, in response to an instruction, audio corresponding to the instruction; and
playing the audio before the matching the motion image of the human with the gesture image currently displayed, and displaying a matching result on the display unit.

18. The non-transitory computer readable storage medium according to claim 15, wherein the matching the motion image of the human with the gesture image currently displayed, and displaying a matching result on the display unit comprising:
extracting a plurality of single-frame images from the motion image of the human;
matching the single-frame image with the gesture image to generate a matching result; and
displaying at least one of a corresponding animation or a corresponding score on the display unit according to the matching result.

19. The non-transitory computer readable storage medium according to claim 16, wherein the extracting, in response to an instruction, a gesture template group corresponding to the instruction comprising:
extracting one or more gesture images from a plurality of pre-stored gesture images to form the gesture template group corresponding to the instruction.

20. The non-transitory computer readable storage medium according to claim wherein the operations further comprising:
calculating, when the matching result comprises a score, a sum of all displayed scores to obtain a total score after the gesture image is already displayed; and
matching the total score with preset score levels, and displaying a level to which the total score belongs on the display unit.
